(19) United States
(12) Patent Application Publication
(10) Pub. No.: US 2003/0204593 A1
(43) Pub. Date: Oct. 30, 2003

(54) System and method for dynamically altering connections in a data processing network

(75) Inventors: Deanna Lynn Quigg Brown, Pflugerville, TX (US); Lilian Sylvia Fernandes, Austin, TX (US); Vinit Jain, Austin, TX (US); Vasu Vallabhaneni, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY

(21) Appl. No.: 10/132,404

(22) Filed: Apr. 25, 2002

(51) Int. Cl. G06F 15/173; G06F 15/16

(52) U.S. Cl. 709/225; 709/203; 709/224

(57) ABSTRACT

A data processing network and system in which a network connection is enabled to migrate among a multitude of available servers and/or clients to provide the connection using the most efficient available set of resources. Typically a server and client would indicate their respective support of this connection migration feature when the connection is established. An operating system or application program would monitor existing connections for characteristics including basic functionality and performance. If an existing connection were found to be faulty or low performing and the client and sever associated with the connection supported connection migration, the software would then determine if an alternative and more effective connection existed. Upon discovering such a connection, the parameters that define the connection would be altered to migrate the connection to the preferred hardware. In an embodiment in which the network connections are established with a transmission control protocol (TCP), each connection includes a four-tuple that completely defines the connection, namely, a source IP address, a source port number, a destination IP address, and a destination port number. By altering one or more of the connection's defining four-tuple, the invention is configured to migrate the connection to a NIC or system that is functioning more efficiently.

### BACKGROUND

1. Field of the Present Invention

The present invention generally relates to the field of data processing networks and more particularly to a network and method permitting an established network connection to migrate its source or destination dynamically in response to changing loads, malfunctions, or other network characteristics.

2. History of Related Art

In a conventional data processing network, client and server systems are connected to the network through a dedicated adapter typically referred to as a network interface card (NIC). Historically, a network connection between any client-server pair in the network is integrally bound to the NIC's of the respective devices. If a connection's hardware elements are nonfunctional or bandwidth constricted, there is no opportunity to alter the connection characteristics to “move” the connection to another piece of hardware that is currently more capable of handling the connection. Instead, the existing connection must be terminated and a new connection established at the cost of potentially significant network overhead. The overhead penalty is particularly relevant in high availability server environments where a primary objective is to provide the highest level of responsiveness to a potentially large number of clients. It would be desirable, therefore, to implement a network method and system that enables network connections to define and alter their configurations dynamically in response to factors such as network loading or hardware failures.

### SUMMARY OF THE INVENTION

The problems identified above are in large part addressed by a data processing network and system in which a network connection is enabled to migrate among a multitude of available servers and/or clients to provide the connection using the most efficient available set of resources. Typically, a server and client would indicate their respective support of this connection migration feature when the connection is established. An operating system or application program would monitor existing connections for characteristics including basic functionality and performance. If an existing connection were found to be faulty or low performing and the client and sever associated with the connection supported connection migration, the software would then determine if an alternative and more effective connection existed. Upon discovering such a connection, the parameters that define the connection would be altered thereby effecting a migration of the connection to the preferred hardware. In an embodiment in which the network connections are established with a transmission control protocol (TCP), each connection includes a four-tuple that fully defines the connection, namely, a source IP address, a source port number, a destination IP address, and a destination port number. By altering one or more of the connection's defining four-tuple, the invention is configured to migrate the connection to a NIC or system that is functioning more efficiently.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing network suitable for implementing one embodiment of the present invention;

FIG. 2 is a block diagram of selected hardware elements of a data processing system suitable for use in the data processing network of FIG. 1;

FIG. 3 is a block diagram of selected elements of the data processing system of FIG. 2;

FIG. 4 is a conceptual illustration of a network connection;

FIG. 5 is a block diagram of selected elements of the network connection of FIG. 4 emphasizing the connection migration features of the present invention; and

FIG. 6 is a conceptual depiction of various connection migration examples contemplated by the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

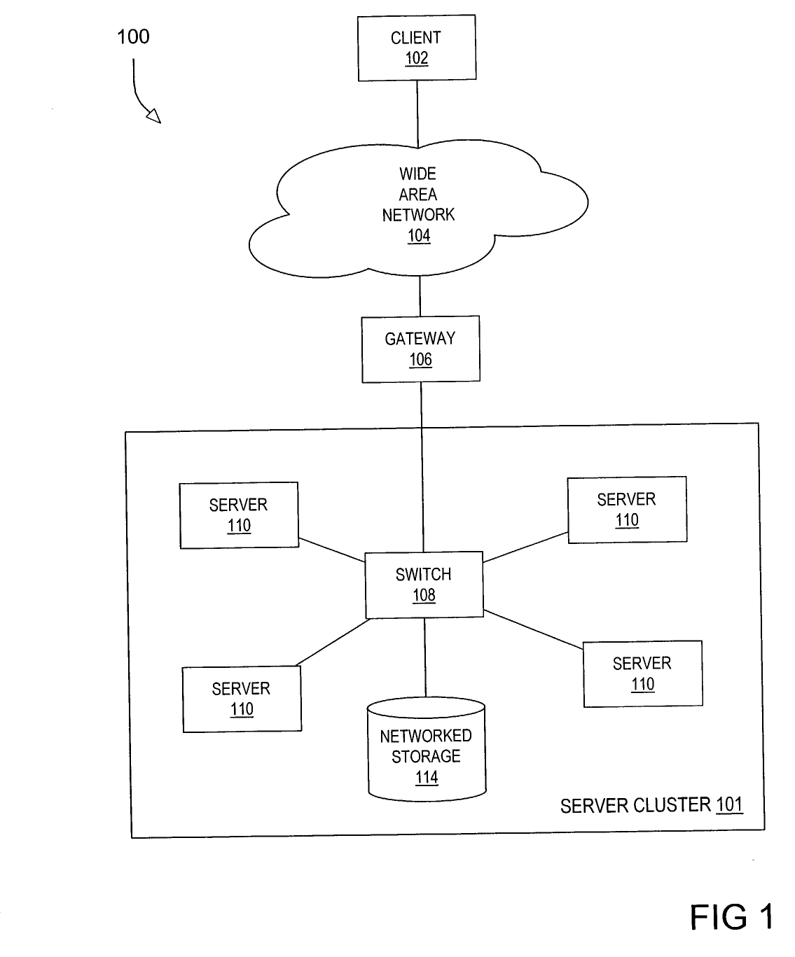

Turning now to the drawings, FIG. 1 is a block diagram of selected elements of a data processing network 100 suitable for implementing one embodiment of the invention. Those skilled in the field of network architecture will appreciate that this particular implementation is but one of many possible configurations. This particular embodiment is illustrated at least in part because of its generality and because it is representative of an increasingly large number of network implementations. In the depicted embodiment, network 100 includes a client system (client) 102 connected to a wide area network 104. Client 102 typically includes a client application program such as a conventional web browser that is executing on a client device.

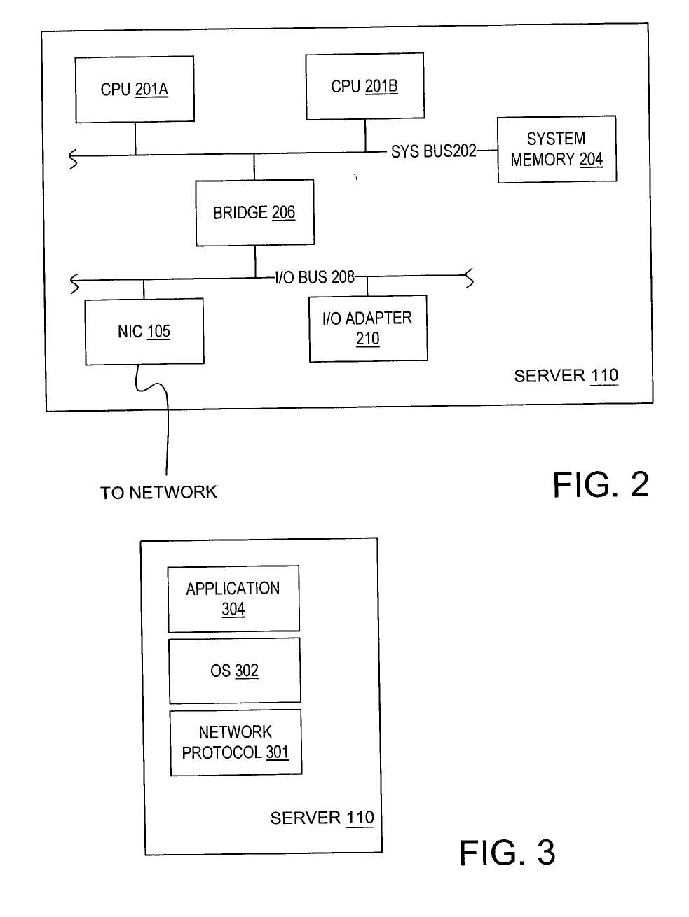

The client device may comprise a desktop or laptop personal computer, a network computer or workstation, or another network aware device such as a personal digital assistant (PDA) or an Internet enabled telephone. Referring briefly to FIG. 2, a block diagram of selected hardware elements of an exemplary client 102 is shown. Client 102 typically includes one or more general purpose microprocessors (CPU's) 201a-201n (generically or collectively CPU(s) 201) interconnected to a system memory 204 via a system bus 202. A bridge device 206 interconnects system bus 202 with an I/O bus 208. I/O bus typically conforms with an industry standard bus specification such as, for example, the Peripheral Components Interconnect (PCI) Local Bus Specification from the PCI Special Interest Group (www.pcisig.org). One or more peripheral or I/O devices are typically connected to I/O bus 208. The depicted embodiment illustrates a Network Interface Card (NIC 105) and a generic I/O adapter 210 connected to I/O bus 208. NIC 105 connects the resources of client 201 to a network medium. In a common implementation, NIC 105 connects client 201 to a local area network such as an Ethernet network. Returning to FIG. 1, client 102 is illustrated as remotely connected to server network 101 through an intervening wide area network (WAN) 104. Other clients (not depicted in FIG. 1) may be locally connected to the server network.

Wide area network 104 typically includes various network devices such as gateways, routers, hub, and one or more local area networks (LANs) that are interconnected with various media possibly including copper wire, coaxial cables, fiber optic cables, and wireless media. Wide area network 104 may represent or include portions of the Internet.

In the depicted embodiment, a server network or server cluster 101 is connected to client 102 through a gateway 106 connected to WAN 104. Server cluster 101 is typically implemented as a LAN that includes one or more servers 110 (four of which are shown). Each server 110 may incorporate substantially the same design features as the client system depicted in FIG. 2 (i.e., one or more microprocessors connected to a shared system memory and having I/O adapters including a NIC connecting the server to a local network). The servers 110 may be networked together over a shared medium such as in a typical Ethernet or token ring configuration. The servers 110 of server cluster 101 typically have access to a persistent (non-volatile) storage medium such as a magnetic hard disk. In addition, any server 110 may include its own internal disk and disk drive facilities. In an increasingly prevalent configuration, persistent storage is provided as a networked device or set of devices. Networked storage is identified in FIG. 1 by reference numeral 114 and may be implemented as one or more network attached storage (NAS) devices, a storage area network (SAN) or a combination thereof.

From a software perspective, clients 102 and servers 110 typically use software components illustrated in FIG. 3 including one or application programs 304, an operating system 302, and a network protocol 301. Application programs 304 may include database applications, web browsers, graphic design applications, spreadsheets, word processors, and the like. Operating system 302 is a general term for software components that manage the resources of the system. Network protocol 301 identifies a suite of software components configured to enable the applications executing on a device to communicate information over the network. Although network protocol 301 is illustrated as distinct from operating system 302 in FIG. 3, the protocol components may comprise components of the operating system.

Application programs and operating system routines launch processes when they are executed. A process executing on server devices such as server device 110 typically transmits data to a requesting process that is executing on a client as a sequence of one or more network packets. Each packet includes a payload comprising a portion of the requested data as well as one or more header fields depending upon the network protocol in use. In an embodiment where WAN 104 represents the Internet, for example, packets transmitted between server 110 and client 102 are typically compliant with the Transmission Control Protocol/Internet Protocol (TCP/IP) as specified in RFC 793 and RFC 791 of the Internet Engineering Task Force (www.ietf.org).

To identify the separate processes that a TCP enabled device or system may handle, TCP provides a unique address for each client-server connection. These unique addresses include an IP address and a port identifier. The IP address identifies a physical location or destination on the network such as a particular NIC. The port identifier is needed because multiple processes may be sharing the same hardware resource (i.e., the same physical resource). The combination of an IP address and a port is referred to as a “socket” that is unique throughout the network. A connection is fully specified by a pair of sockets with one socket typically representing the client side socket and the socket representing the server side socket.

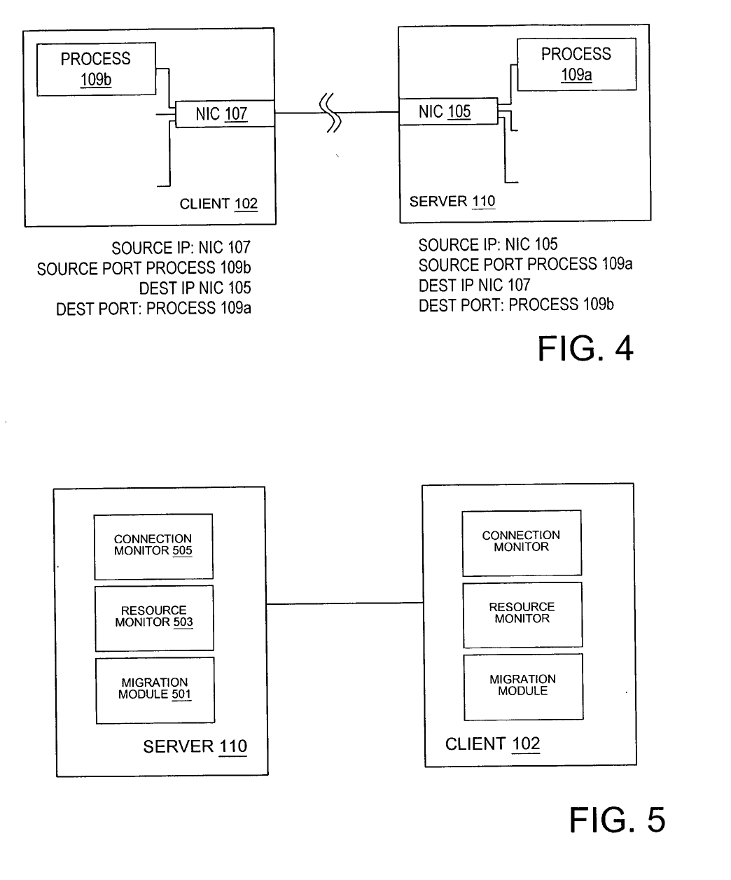

Referring now to FIG. 4, a conceptualized illustration of a client-server connection is depicted. The illustrated connection is representative of a TCP compliant connection between a process 109a executing on server 110 and process 109b executing on client 102. The connection is defined by a pair of sockets. From the perspective of server 110, the source socket is determined by the combination of the IP address of NIC 105 and the port number associated with process 109a while the destination socket is determined by the combination of the IP address of NIC 107 and the port number associated with process 109b on client 102. From the perspective of client 102, the source and destination sockets are reversed such that NIC 107 and process 109b defined the source socket while NIC 105 and process 109a define the destination socket. In a conventional data processing network, the connection definition is static. The source and destination sockets on both sides of the connection are invariant. The present invention addresses this limitation by enabling the client and server to alter an existing connection definition cooperatively when it would be advantageous to do so. The connection migration functionality is preferably achieved by extending the features of the network protocol. In this embodiment, both parties to a connection must agree beforehand that they support connection migration. If either party does not support the extension, the feature is disabled by the other party.

Portions of the invention may be implemented in software comprised of a sequence of computer executable instructions stored on a computer readable medium. When the instructions are being executed, they are typically stored in a volatile storage medium such as the system memory (typically comprising DRAM) of a client or server system or an internal or external cache memory (typically comprising SRAM). At other times, the software may be stored on a non-volatile medium such as a hard disk, floppy diskette, CD ROM, DVD, flash memory card or other electrically erasable medium, magnetic tape, and the like. In addition, portions of the software may be distributed over various element of the network. For example, portions of the software may reside on a client system while other portions reside on a server system.

Referring now to FIG. 5, selected software elements according to one embodiment of the present invention are depicted. In the depicted embodiment, a server 110 includes a migration module 501, a resource monitor 503, and a connection monitor 505. These elements coexist with the server's operating system and network protocol modules. The connection monitor 505 is responsible for monitoring the performance of one or more network connections in which server 110 is participating. Connection monitor 505 may be implemented as a stand-alone application program or provided as an operating system or network protocol utility. Typically, connection monitor 505 is configured to gauge one or more performance characteristics of the server's active network connections. The monitored performance characteristics may include basic connection functionality and connection throughput. Basis functionality may be determined by monitoring the number or frequency of time out events, where a time out event represents a packet that was served but not acknowledged within a prescribed time period. Connection throughput may be monitored by, for example, monitoring the time that elapses between the delivery of a packet and the receipt of an acknowledgement for the packet. From this information and information about the size of each packet, connection monitor 505 is configured to arrive at an estimate of the connection's “speed.”

Migration module 501 is configured to interact with connection monitor 505 to determine if a particular connection is a candidate for migration. In one embodiment, connection monitor 505 communicates to migration module whenever a monitored performance characteristic of a connection is non-compliant with a standard or threshold. If, for example, a monitored connection's basic functionality is determined to be faulty, connection monitor 505 is configured to report the connection to migration module 501. The performance standards that define when a monitored connection is reported as a candidate for migration may comprise a set of predetermined and standards. Alternatively, the performance standards may be determined dynamically based on the connections' recent history.

In response to connection monitor 505 reporting a monitored connection as falling below some performance standard, migration module 501 will first determine if the other party to the connection supports connection migration. When a connection is established with a client or server that supports connection migration, the client or server will query the other party to determine if the other party supports migration. If both parties to the connection support migration, both parties will tag the connection appropriately. A party may attempt to determine whether the other party supports migration by sending a special purpose packet or including a special purpose header field when the connection is being established. If either party does not support the migration feature, the migration feature is disabled by the other party.

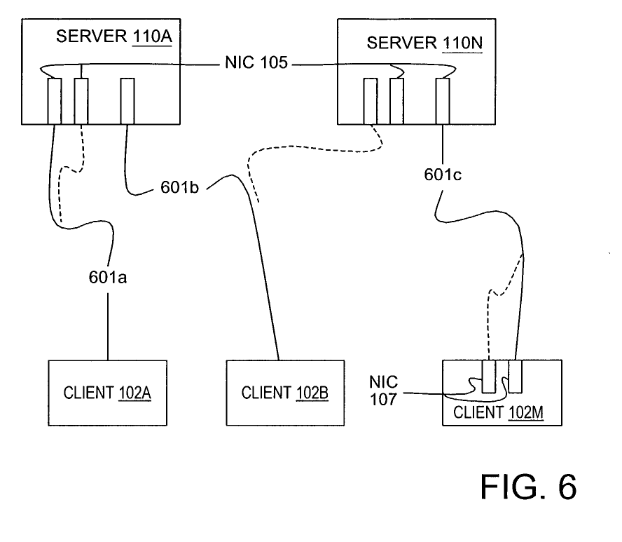

Assuming that both parties to a connection support the migration feature, migration module 501 is configured to attempt to migrate (modify) an existing connection in response to a prompt from connection monitor 505. In the embodiment depicted in FIG. 5, migration module 501 will consult resource monitor 503 to determine if alternative resources are available for providing a connection. Resource monitor 503 is typically configured to maintain an inventory of resources available for providing network connections. Referring momentarily to FIG. 6, each server 110 and each client 102 may have multiple network interface cards. Server 110 may be implemented with, for example, an pSeries 690 server from IBM Corporation having as many as 160 hot-pluggable PCI slots each capable of supporting a network interface card. Similarly, high availability client systems may also have multiple network adapters. When a server or client includes multiple network adapters, the additional adapters may be available as alternative resources for providing a particular network connection. When migration module 501 attempts to migrate a connection, it queries resources monitor 503 to provide a list of available resources.

In one embodiment, resource monitor 503 may simply provide the list of all the available resources each time migration module 501 initiates a request. In another embodiment, resource monitor 503 may indicate the available resources selectively or in a prioritized manner depending upon various factors including, for example, the identity of the client. This embodiment contemplates the prioritization of available resources to provide differing levels of service to different clients. A service provider could offer to provide different classes of service to different classes of clients. Resource monitor 503 may make resources available to a client that subscribes to the highest class of service that are not made available to a client subscribing to a lower class of service. Other prioritization criteria may also be used to determine which resources are available to a client.

The client 102 depicted in FIG. 5 is shown as including software components substantially analogous to the components indicated for server 110. Thus, each client 102 may include its migration module, connection monitor, and resource monitor. In this manner, connection performance may be monitored on both sides of the connection and both sides of the connection may initiate a migration of the connection to other resources.

When a connection migration is initiated by either party to the connection, migration module 501 will begin the migration by suspending the transmission of any new packets. When all outstanding packets (i.e., packets that have been delivered, but not acknowledged) are either acknowledged or timed-out, migration module 501 can then alter the socket definition for either one or both of the connection's parties. After the socket definition(s) are changed, the four-tuple defining the connection is then altered accordingly on the client and server side. Thus, if a particular connection migration involves client 102 changing its socket definition while the socket for server 110 remains the same, the client side four tuple is subsequently modified by changing the source IP address/port number combination to reflect the modified client-side socket definition. Server 110 would then also modify its connection four-tuple by changing its destination IP address/port number combination.

Referring now to FIG. 6 again, a conceptualized illustration of the connection migration contemplated by the present invention is presented. In this depiction, a set of network connections 601a-601c are connected between a set of clients 102a-102m and a set of servers 110a-110n. Each client 102 has at least one NIC 107 available for providing one or more network connections while each server 110 has at least one NIC 105. In FIG. 6, three types of connection migration are illustrated. Connection 601a, which represents an intra-server migration, is shown in solid line as connected between a first NIC 105 of server 110a where the solid line represents the original network connection. After connection migration, connection 601a is between client 102a and a second NIC of server 110a as shown in the dotted line. Connection 601b represents an inter-server migration in which the original connection, between client 102b and a first server 110a is migrated to a second connection (shown by the dashed line) between server 102b and a second server 10n. This inter-server migration might be implemented, for example, in a server cluster environment as depicted in FIG. 1 where server cluster 101 includes multiple servers 110 all connected to a common switch 108. In this environment, the migration modules 501 and connection monitors 505 might be distributed to each server 110 while resource monitor 503 might be installed on switch 108 where the resources available throughout the cluster can be centrally monitored. Connection 601c illustrates an intra-client connection migration in which a connection initially defined by a first NIC 107 on client 102m is migrated to a second NIC on the client. By enabling intra-server, inter-server, and intra-client migration, the present invention maximizes system flexibility.

It will be apparent to those skilled in the art having the benefit of this disclosure that the present invention contemplates a system and method for managing connections in a network environment. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method of managing a network connection between a client and a server in a data processing network, comprising:
monitoring at least one performance characteristic of the connection;
maintaining an inventory of resources available for providing network connections; and
responsive to determining the monitored performance characteristic as indicating a problem with the network connection, altering the connection by changing at least one resource defining the connection to a resource selected from the inventory of available resources.

2. The method of claim 1, wherein the monitored performance characteristic comprises the basic functionality of the connection.

3. The method of claim 2, wherein basic functionality is monitored by detecting the number of packet time out events.

4. The method of claim 1, wherein the monitored performance characteristic is indicative of the response time of the connection.

5. The method of claim 1, wherein changing a resource comprises changing the Internet Protocol (IP) address of a server side socket defining the connection.

6. The method of claim 5, wherein changing the IP address comprises moving the connection from a first network interface card of the server to a second network interface card of the server.

7. The method of claim 5, wherein changing the IP address comprises moving the connection from a first network interface card of a first server to a second network interface card on a second server.

8. The method of claim 1, further comprising identifying the client and server as supporting migration prior to establishing the connection.

9. The method of claim 1, wherein changing a resource comprises changing the IP address of a client side socket defining the connection.

10. The method of claim 9, wherein changing the IP address comprises moving the connection from a first network interface card of the client to a second network interface card of the client.

11. A computer program product comprising a sequence of computer executable instructions for managing a network connection between a client and a server in a data processing network, the instructions residing on a computer readable medium and comprising:
computer code means for monitoring at least one performance characteristic of the connection;
computer code means for maintaining an inventory of resources available for providing network connections; and
computer code means for altering the connection, responsive to determining the monitored performance characteristic as indicating a problem with the network connection, by changing at least one resource defining the connection to a resource selected from the inventory of available resources.

12. The computer program product of claim 11, wherein the monitored performance characteristic comprises the basic functionality of the connection.

13. The computer program product of claim 12, wherein basic functionality is monitored by detecting the number of packet time out events.

14. The computer program product of claim 11, wherein the monitored performance characteristic is indicative of the response time of the connection.

15. The computer program product of claim 11, wherein the code means for changing a resource comprise code means for changing the Internet Protocol (IP) address of a server side socket defining the connection.

16. The computer program product of claim 15, wherein the code means for changing the IP address comprise code means for moving the connection from a first network interface card of the server to a second network interface card of the server.

17. The computer program product of claim 15, wherein the code means for changing the IP address comprise code means for moving the connection from a first network interface card of a first server to a second network interface card on a second server.

18. The computer program product of claim 11, further comprising code means for identifying the client and server as supporting migration prior to establishing the connection.

19. The computer program product of claim 11, wherein the code means for changing a resource comprise code means for changing the IP address of a client side socket defining the connection.

20. The computer program product of claim 19, wherein changing the IP address comprises moving the connection from a first network interface card of the client to a second network interface card of the client.

21. A data processing system including at least one processor connected to memory, comprising:
computer means for monitoring at least one performance characteristic of the connection;
computer means for maintaining an inventory of resources available for providing network connections; and
computer means for altering the connection, responsive to determining the monitored performance characteristic as indicating a problem with the network connection, by changing at least one resource defining the connection to a resource selected from the inventory of available resources.

22. The data processing system of claim 21, wherein the monitored performance characteristic comprises the basic functionality of the connection.

23. The data processing system of claim 22, wherein basic functionality is monitored by detecting the number of packet time out events.

24. The data processing system of claim 21, wherein the monitored performance characteristic is indicative of the response time of the connection.

25. The data processing system of claim 21, wherein the computer means for changing a resource comprise computer means for changing the Internet Protocol (IP) address of a server side socket defining the connection.

26. The data processing system of claim 25, wherein the computer means for changing the IP address comprise computer means for moving the connection from a first network interface card of the server to a second network interface card of the server.

27. The data processing system of claim 25, wherein the computer means for changing the IP address comprise computer means for moving the connection from a first network interface card of a first server to a second network interface card on a second server.

28. The data processing system of claim 21, further comprising computer means for identifying the client and server as supporting migration prior to establishing the connection.

29. The data processing system of claim 21, wherein the computer means for changing a resource comprise computer means for changing the IP address of a client side socket defining the connection.

30. The data processing system of claim 29, wherein changing the IP address comprises moving the connection from a first network interface card of the client to a second network interface card of the client.
